(19) United States
(12) Patent Application Publication
(10) Pub. No.: US 2001/0047517 A1
(43) Pub. Date: Nov. 29, 2001

(54) Method and apparatus for intelligent transcoding of multimedia data

(76) Inventors: Charilaos Christopoulos, Sollentuna (SE); Niklas Bjork, Sundbyberg (SE); Joel Askelof, Stockholm (SE)

Correspondence Address: BURNS DOANE SWECKER & MATHIS L L P, POST OFFICE BOX 1404, ALEXANDRIA, VA, 22313-1404, US

(21) Appl. No.: 09/773,590

(22) Filed: Feb. 2, 2001

Related U.S. Application Data
(60) Provisional application No. 60/181,565, filed on Feb. 10, 2000.

(51) Int. Cl. H04N 7/173

(52) U.S. Cl. 725/87; 725/131

(57) ABSTRACT

A method and apparatus is described for performing intelligent transcoding of multimedia data between two or more network elements in a client-server or client-to-client service provision environment. Accordingly, one or more transcoding hints associated with the multimedia data may be stored at a network element and transmitted from one network elements to another. One or more capabilities associated with one of the network elements may be obtained and transcoding may be performed using the transcoding hints and the obtained capabilities in a manner suited to the capabilities of the network element. Multimedia data includes still images, and capabilities and transcoding hints include bitrate, resolution, frame size, color quantization, color pallette, color conversion, image to text, image to speech, Regions of Interest (ROI), or wavelet compression. Multimedia data further may include motion video, and capabilities and transcoding hints include rate, spatial resolution, temporal resolution, motion vector prediction, macroblock coding, or video mixing.

This application claims priority under 35 U.S.C. §119(e) to U.S. Provisional Application No. 60/181,565 filed Feb. 10, 2000, the entire disclosure of which is herein expressly incorporated by reference.

### BACKGROUND

The present invention relates to multimedia and computer graphics processing. More specifically, the present invention relates to the delivery and conversion of data representing diverse multimedia content, e.g. audio, image, and video signals from a native format to a format fitting the user preferences, capabilities of the user terminal and network characteristics.

Advances in computers and growth in communication bandwidth have created new classes of computing and communication devices such as hand-held computers, personal digital assistants (PDAs), smart phones, automotive computing devices, and computers that allow users more access to information. Modern mobile phones may now be equipped with built-in calendars, address books, enhanced messaging, and even Internet browsers. PDAs, too, are being equipped with network capabilities and are now capable of processing, for example, streaming audio-visual information of the kind generally referred to as multimedia. Modern users are requiring equipment capable of universal access anywhere, anytime.

One problem associated with unlimited access to multimedia information using any kind type of equipment, client, and network is the ability of user devices to universally process multimedia information. Some standards have been under development for the universal processing of multimedia data by a variety of access devices as will be described in greater detail herein below. The general objective of universal access systems is to create different presentations of the same information originating from a single content-base to suit different formats, devices, networks and user interests associated with individual access devices. Thus the goal of universal access is to provide the same information through appropriately chosen content elements. An abstract example would be a consumer who receives the same news story through television media, newspaper media, or electronic media, e.g. the Internet. Universal access relates to the ability to access the same rich multimedia content regardless of the limitations imposed by a client device, client device capabilities, characteristics of the communication link or characteristics of the communication network. Stated differently, universal access allows an access device with individual limitations to obtain the highest quality content possible, whether as a function of the limitations or as a function of user specification of preference. The growing importance of universal access is supported by forecasts of tremendous and continuing proliferation of access capable computing devices, such as hand-held computers, personal digital assistants (PDAs), smart phones, automotive computing devices, wearable computers, and so forth.

Many access device manufacturers, including manufacturers of, for example, cell phones, PDAs, and hand-held computer manufacturers, are working to increase the functionality of their access devices. Devices are being designed with capabilities including, for example, the ability to serve as a calendar tool, an address book, a paging device, a global positioning device, a travel and mapping tool, an email client, and an Internet browser. As a result, many new businesses are forming to provide a diversity of content to such access devices. Due, however, to the limited capabilities of many access devices in terms of, for example, display size, storage capacity, processing power, and the characteristics of the network, for example network access bandwidth, challenges arise in designing applications which allow access devices having limited capabilities to access, store and process full format information in accordance with the limited capabilities of each individual device.

Concurrent with developments in access devices and device capabilities, recent advances in data storage capacity, data acquisition and processing, and network bandwidth technologies such as, for example, ADSL, have resulted in the explosive growth of rich multimedia content. Accordingly, a mismatch has arisen between the rich content presently available and the capabilities of many client devices to access and process it.

It is reasonable to expect that with continued growth, future content will include, for example, a wide range of quality video services such as, for example, HDTV, and the like. Lower quality video services such as the video-phone and video-conference services will further be more widely available. Multimedia documents or “objects” containing, for example, audio and video will most likely not only be retrieved over computer networks, but also over telephone lines, ISDN, ATM, or even mobile network air interfaces. The corresponding potential for transmission of content over several types of links or networks, each having different transfer rates and varying traffic loads may require an adaptation of the desired transfer rate to the available channel capacity. A main constraint on universal access systems is that decoding of content at any level below that associated with the original, native, or transmitted format should not require complete decoding of the transmitted content in order to obtain content in a reduced format.

To allow audio-visual information to be delivered to any client independently of its capabilities (including user preferences, channel capacity, etc.), various methods may be used. For example, multiple versions of particular multimedia content may be stored in a database associated with a content server, with each version suitable for requirements associated with clients having particular capabilities. Problems arise however in that storing different versions to accommodate different client capabilities results in excessive storage requirements particularly if every possible permutation of client capability is considered. It should be noted, given that some clients can accept only audio, some only video, some low resolution video, some low frame rate video, some color and some grey scale video, and the like, that the number of permutations of capabilities needing support for a single item of content may grow prohibitively large.

Another possible solution would be to have one or a limited number of versions of the multimedia content stored and perform necessary conversions at the server or gateway upon delivery of content such that the content is adapted to terminal/client capabilities and preferences. For example, assuming an image of a size 4K×4K is stored in a server, a particular client may require only that a 1K×1K image be provided. The image may be converted or transcoded by the server or a gateway before delivery to the client. Such an example may further be described in International Patent Application PCT/SE98/00448 1998, entitled “Down-Scaling of Images” by Charilaos Christopoulos and Athanasios Skodras, which is herein expressly incorporated by reference.

As a further example, assume that a video segment is stored in CIF format and a particular client can accept only QCIF format. The video may be converted or transcoded in the server or a gateway in the network from CIF to QCIF in real time and delivered to the client as is described in greater detail in International Patent Application PCT/SE97/01766, 1997, entitled “A Transcoder,” by Charilaos Christopoulos and Niklas Björk, and in a paper entitled “Transcoder Architectures For Video Coding”, by Björk N. and Christopoulos C., IEEE Transactions on Consumer Electronics, Vol. 44, No. 1, pp. 88-98, February 1998, both of which are herein expressly incorporated by reference.

Other techniques for delivering content to clients having various capabilities involve delivery of key frames to the client. Such a method is particularly well suited for clients not equipped to handle high frame rate video, as for example is described in Swedish Patent Application 9902328-5, Jun. 18, 1999, entitled “A Method and a System for Generating Summarized Video”, by Yousri Abdeljaoued, Touradj Ebrahimi, Charilaos Christopoulos and Ignacio Mas Ivars, which is herein expressly incorporated by reference.

It can be seen then that the problem of universal access is generally associated with the way in which image, video, multidimensional images, World Wide Web pages with text, and the like are transmitted to subscribers with different requirements for picture quality, and the like based on, for example, processing power, memory capability, resolution, bandwidth, frame rate, and the like.

Yet another solution to the problem of universal access, i.e. satisfying the different requirements of content delivery clients, is by providing content by way of scalable bitstreams in accordance with, for example, video standards such as H.263, MPEG 2/4. Scalability, generally requires no direct interaction between transmitter and receiver, or server and client. Generally, the server is able to transfer a bitstream associated with a particular piece of multimedia content consisting of various layers which may then be processed by clients according to different requirements/capabilities in terms of resolution, bandwidth, frame rate, memory or computational capacity. The maximum number of layers in such a bitstream is often related to the computational capacity of the system responsible for originally creating the multilayer representation. If new clients are added which do not have the same requirements/capabilities as clients for which the bitstream was previously configured, then the server may be reprogrammed to accommodate the requirements of the new clients. It should further be noted that in accordance with existing scalable bitstream standards, the capabilities of clients in decoding content must be known in advance in order to create the appropriate bitstream. Moreover, due to overhead associated with each layer, design of a scalable bitstream may result in a higher actual number of bits overall compared to a single bitstream for achieving a similar quality. Further, coding scalable bitstreams may also require a number of relatively powerful encoders, corresponding to the number of different clients.

Yet another different solution to the problem of universal access involves the use of transcoders. A transcoder is a device which accepts a received data stream encoded according to a first coding format and outputs an encoded data stream encoded according to a second coding format. A decoder coupled to such a transcoder and operating according to the second coding format would allow reception of the transcoded signal originally encoded and transmitted according to the first coding scheme without modifying the original encoder. For example, such a transcoder could be used to convert a 128 kbit/s video signal conforming to ITU-T standard H.261, from an ISDN video terminal for transmission to a 28.8 Kbit/s signal over a telephone line using ITU-T standard H.263. Existing transcoding methods assume that the transcoder makes the right decision on how a signal should be transcoded. However, there are cases where such assumptions can lead to problems. Assuming, for example, a still image is stored in a server and compressed at 1 bits per pixel (1 bpp) and a transcoder decides that the image will be recompressed at 0.2 bpp in order to deliver it quickly to a client having a low bandwidth connection. Such a decision will result in the quality of the image being reduced. Although such a compression decision will improve the speed of the delivery, the decision by the transcoder fails to take into account that certain parts of the image, for example, Regions of Interest (ROIs), might be of more importance than the rest of the image. Since existing transcoders are not aware of the importance of the signal content, all input is handled in a similar manner.

As still another example, assume that a compound document having, for example, text and images is compressed as an image using the upcoming Joint Photographic Experts Group (JPEG) JPEG2000 still image coding standard to be released as standard ISO 15444 or the existing JPEG standard such as, for example, IS 10918-1 (ITU-T T.81). If such a compound document is compressed as an image and is to be accessed by a client lacking the capability to decode images, i.e., a PDA with limited display capabilities, then there will be no way to deliver at least the text portion of the compound image to the client. If however, client capabilities were known intelligent decisions could be made regarding the compound document and the text could at least be delivered to the client. Presently there are no available methods in the prior art to allow such intelligent handling of multimedia content.

Yet another example may be the case where a transcoder reduces the resolution of a video segment to fit the capabilities of a particular client. As in the previous example described in connection with International Patent Application PCT/SE97/01766, 1997 supra, the transcoder described therein when transcoding video of CIF format to QCIF format motion vectors (MVs) associated with the original video may be reused as may be further described, for example, in “Transcoder Architectures for video coding”, supra, and in the article entitled “Motion Vector refinement for high performance transcoding”, by J. Youn, M. -T. Sun,, IEEE Trans. on Multimedia, Vol. 1. No. 1, March 1999 which is herein expressly incorporated by reference.

It should be noted that, since MV's were extracted based on CIF resolution video encoding, they are not fully compatible for QCIF resolution video decoding. Accordingly, MV refinement may need to be performed in the QCIF transcoded video stream. Depending on the complexity of the video, i.e. the amount of motion, refinement may be done in an area [−1,1] up to [−7, 7] pixels around the extracted MV although larger refinement areas may also be possible. Since a transcoder does not know which refinement area will be used, large area refinement might erroneously be performed on a MV associated with a small area therefore producing a poor quality transcoded QCIF video stream particularly when high motion video CIF video was input to the transcoder. Further, unnecessary computational complexity might be added when a large refinement area was selected and low motion CIF input was used. Still further, certain scenes of a video stream might be associated with high activity while other scenes might be of low activity rendering any fixed refinement choice inefficient overall It would therefore be useful to know which parts of the video stream would use large refinement area and in which it will use small refinement area.

The working group preparing specifications associated with the upcoming MPEG-7 standard called “Multimedia Content Description Interface”, is investigating technologies for Universal Multimedia Access (UMA). UMA relates to delivery of AV or multimedia information to clients with various capabilities. MPEG-7 focuses on technologies for key frame extraction, shot detection, mosaic construction algorithms, video summarization technologies, and the like, as well as associated Descriptors (D's) and Description Schemes (DS's). Also, D's and DS's for color information such as, for example, color histogram, dominant color, color space, camera motion, texture and shape are included. MPEG-7 uses meta-data information for intelligent search and filtering of multimedia content. However, MPEG-7 is not concerned with providing better compression of multimedia content.

Thus, it can be seen that while MPEG-7 and other scheme may partially address the problem of universal access, the difficulty posed by, for example, lack of intelligence in making transcoding decisions remains unaddressed. In order to maximize integration of various quality multimedia services, such as, for example, video services, a single coding scheme which can provide a range of formats would be desirable. Such a coding scheme would enable users, both clients and servers capable of processing and providing different qualities of multimedia content to communicate with each other.

### SUMMARY

A method and apparatus for providing intelligent transcoding of multimedia data between two or more network elements in a client-server or a client-to-client service provision environment is described in accordance with various embodiments of the present invention.

Accordingly, the present invention is directed to methods and apparatus for converting multimedia information comprising. Multimedia information is requested from a converter. The multimedia information along with conversion hints are received. The multimedia information is converted in accordance with the conversion hints. The multimedia information is provided to the requestor.

In accordance with another aspect of the present invention a multimedia storage element stores multimedia information. A converter element receives multimedia information from the multimedia storage element. The converter element converts multimedia information using conversion hints and delivers the converted multimedia information to the client.

In accordance with exemplary embodiments of the present invention the converter is a transcoder and the converter hints are transcoding hints.

### BRIEF DESCRIPTION OF THE DRAWINGS

The objects and advantages of the invention will be understood by reading the following detailed description in conjunction with the drawings, in which:

FIG. 1 illustrates an exemplary system for transcoding media in accordance with the present invention;

FIG. 2 illustrates the storage of multimedia data and associated transcoder hints in accordance with exemplary embodiments of the present invention;

FIG. 3 illustrates an exemplary method for providing multimedia data to a client in accordance with the present invention;

FIG. 4 illustrates still image transcoding hints in accordance with exemplary embodiments of the present invention;

FIG. 5 illustrates video transcoding hints in accordance with exemplary embodiments of the present invention;

FIG. 6 illustrates a resolution reduction oriented intelligent transcoder in accordance with exemplary embodiments of the present invention;

FIG. 7 illustrates an exemplary downscaling of motion vectors in accordance with the present invention; and

FIG. 8 illustrates an exemplary downscaling of macroblocks in accordance with the present invention.

### DETAILED DESCRIPTION

The present invention is directed to communication of multimedia data. Specifically, the present invention formats multimedia data in accordance with client and/or user preferences through the use of the multimedia data and associated transcoder hints used in the transcoding of the multimedia data.

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well known methods, devices, and circuits are omitted so as not to obscure the description of the present invention.

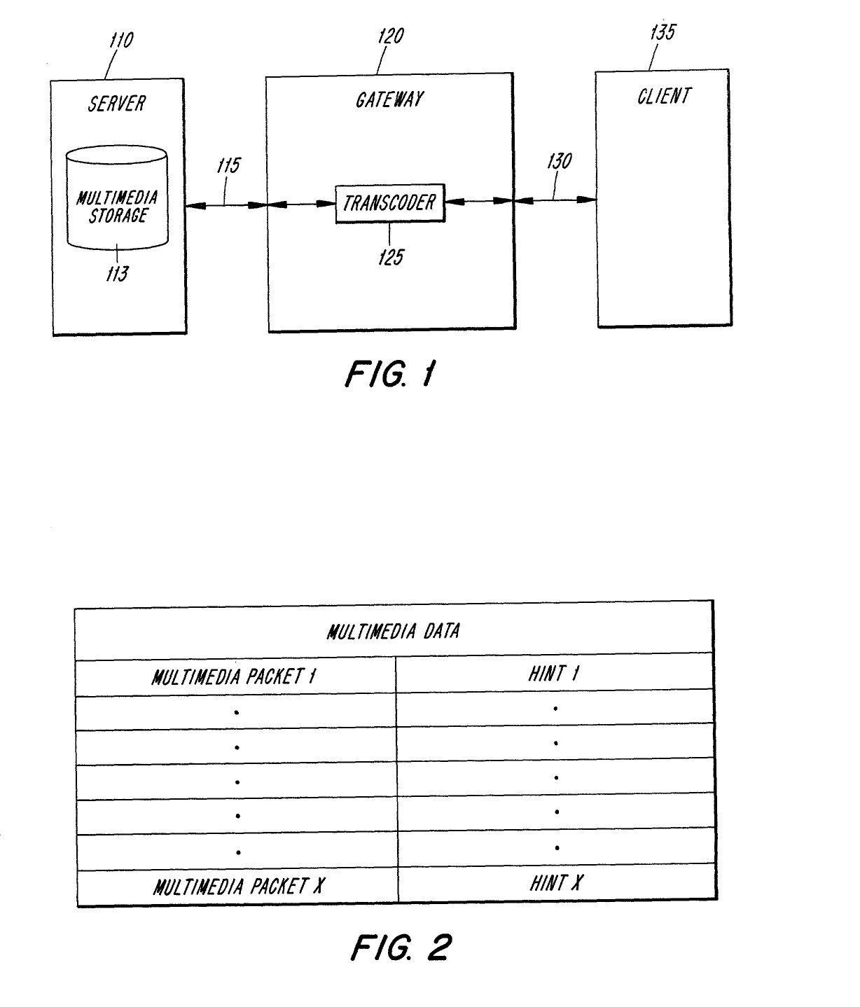

FIG. 1 illustrates various network components for the communication of multimedia data in accordance with exemplary embodiments of the present invention. The network includes a server 110, a gateway 120 and client 130. Server 110 stores multimedia data, along with transcoding hints, in multimedia storage element 113. Server 110 communicates the multimedia data and the transcoder hints to gateway 120 via bidirectional communication link 115. Gateway 120 includes a transcoder 125. Transcoder 125 reformats the multimedia data using the transcoder hints based upon client capabilities, user preferences, link characteristics and/or network characteristics. The transcoded multimedia data is provided to client 135 via bidirectional communication link 130. It will be recognized that bidirectional communication links 115 and 130 can be any type of bidirectional communication links, i.e., wireless or wire line communication links. Further, it will be recognized that the gateway can reside in the server 110 or in the client 135. In addition, the server 110 can be a part of another client, e.g., the server 110 can be a hard disk drive inside another client.

FIG. 2 illustrates the storage of the multimedia data and the associated transcoder hints. As illustrated in FIG. 2, each multimedia packet includes associated transcoder hints. These transcoder hints are used by a transcoder to reformat the multimedia data in accordance with client capabilities, user preferences, link characteristics and/or network characteristics. It will be recognized that FIG. 2 is meant to be merely illustrative, and that the multimedia data and associated transcoder hints may not necessarily be stored in the manner illustrated in FIG. 2. As long as the multimedia data is associated with the particular transcoder hints, this information can be stored in any manner. The type of transcoder hints which are stored depend upon the type of multimedia data.

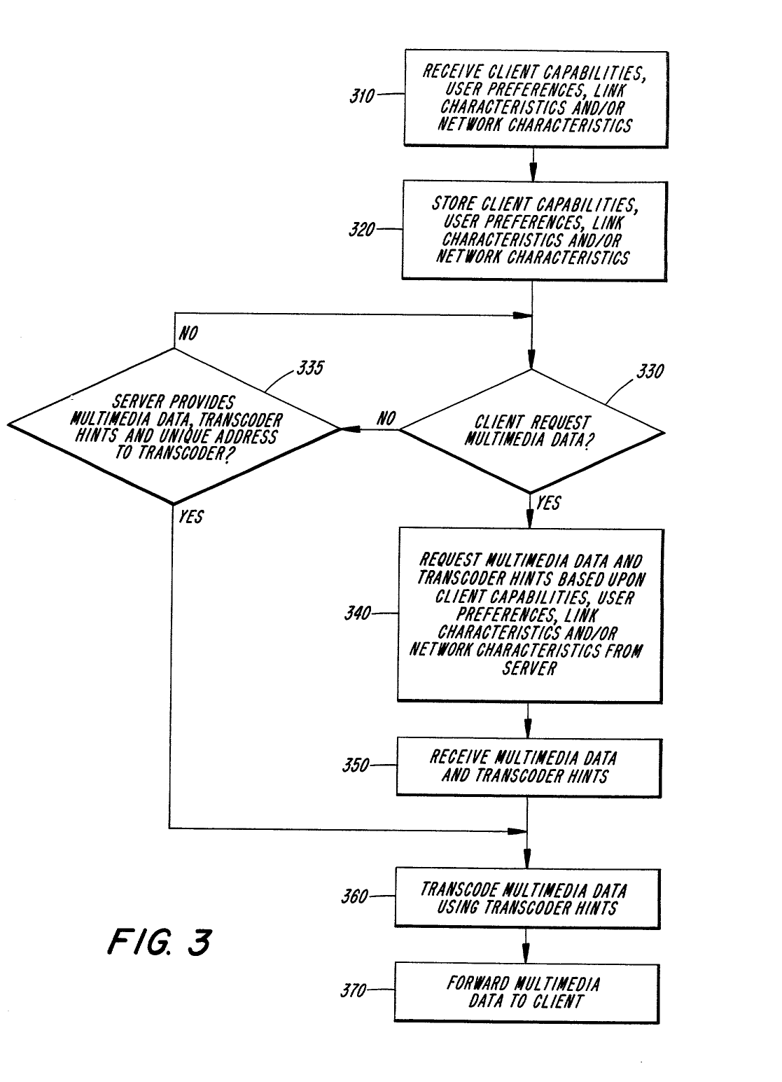

FIG. 3 illustrates an exemplary method for providing multimedia data to a client in accordance with exemplary embodiments of the present invention. Initially, the transcoder is provided with the client capabilities, user preferences, link characteristics and/or network characteristics (step 310). The transcoder then stores the client capabilities, user preferences, link characteristics and/or network characteristics (step 320). The transcoder then determines whether it has received a request for multimedia data from a client (step 330). If the transcoder does not receive a request from the client for multimedia data (“NO” path out of decision step 330), the transcoder determines whether the server has provided it with multimedia data, transcoder hints and a unique address, e.g., an I.P. address, for the client to which the multimedia data is intended (step 335). If the server provides the transcoder with multimedia data, transcoder hints and a unique address (“YES” path out of decision step 335) the transcoder transcodes the multimedia data using the transcoder hints (step 360). Once the multimedia data has been transcoded, the transcoder forwards the multimedia data to the client based upon the unique address (step 370). If the server has not provided multimedia data, transcoder hints and a unique address to the transcoder (“NO” path out of decision step 335) the transcoder determines whether the client has requested multimedia data (step 330).

If the transcoder receives a request from the client for multimedia data (“YES” path out of decision step 330), the transcoder requests the multimedia data and transcoder hints from the server (step 340). The transcoder requests transcoder hints from the server based upon the user preferences, client capabilities, link characteristics and/or network characteristics. The transcoder receives the multimedia data and transcoder hints (step 350) and transcodes the multimedia data using the transcoder hints (step 360). Once the multimedia data has been transcoded, the transcoder forwards the multimedia data to the client (step 370). It will be recognized that the receipt of and storage of client capabilities, user preferences, link characteristics and/or network characteristics is normally only performed during an initialization process between the client and the transcoder. After this initialization process, the transcoder can request the transcoder hints from the server based upon these stored client capabilities, user preferences, link characteristics and/or network characteristics. However, it should also be recognized, that the user can update the client capabilities, user preferences, link characteristics and/or network characteristics at any time prior to the transcoder requesting multimedia data from the server.

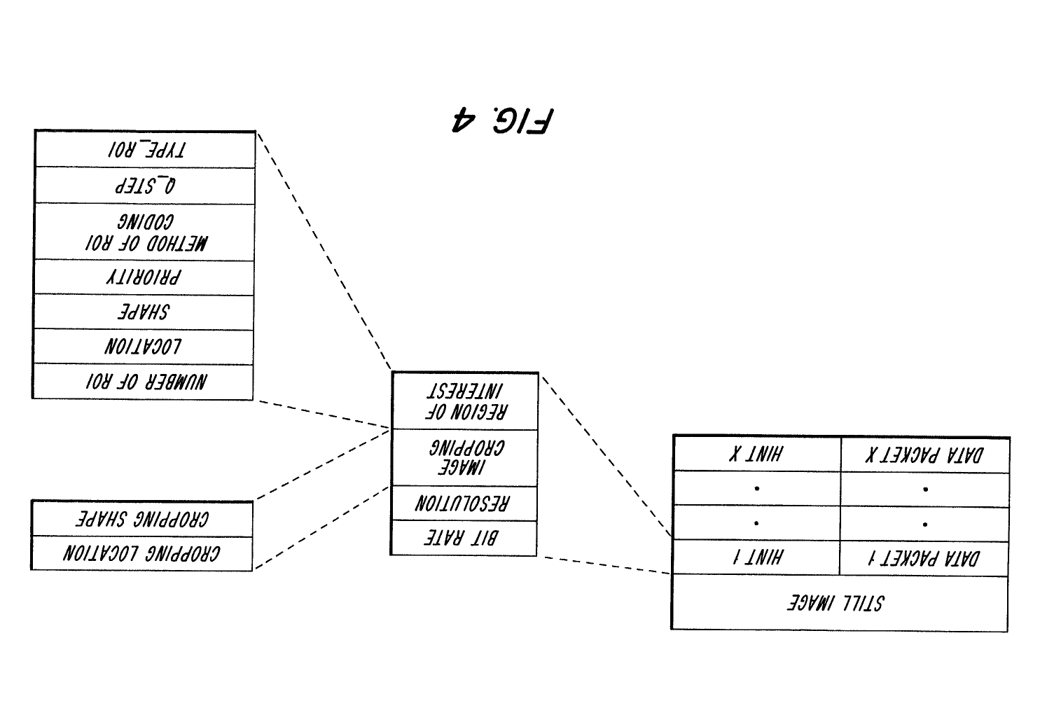

Now that the general operation of the present invention has been described, the application of the present invention using various types of multimedia data will be described to highlight exemplary applications of the present invention. FIG. 4 illustrates the storage of a still image information and associated transcoder hints. As illustrated in FIG. 4, the type of transcoder hints for still images can include bit rate, resolution, image cropping and region of interest transcoder hints. Images stored in a database may have to be transmitted to clients with reduced bandwidth capabilities. For example, an image stored at 2 bpp may have to be transcoded at 0.5 bits per pixel (bpp) in order to be transmitted quickly to a client. In the case of a JPEG compressed image, a requantization of the discrete consine transform (DCT) coefficients would be performed. Encoding an image at a specific bit rate requires the transcoder to perform an iterative procedure to determine the proper quantization factors for achieving a specific bit rate. This iterative procedure adds significant delays in the delivery of the image and increases the computational complexity in the transcoder. To reduce the delays and the computational complexity in the transcoder, the transcoder can be informed of which quantization factor to use in order to achieve a certain bit rate or to re-encode the image at a bit rate that is a certain percentage of the one that the image is initially coded, or a certain range of bit rates.

Resolution transcoding hints concern the resolution of the still image as a whole. Image cropping transcoding hints can include information about the cropping location and the cropping shape. Image cropping hints can also include information informing the transcoder whether it is more preferable to provide a full version of the image with a less background quality or whether it is preferable to crop the image to only contain a specific region of interest. Accordingly, if an image cannot conform to the client's display capabilities and/or bandwidth capabilities, the image may be cropped such that the most important information of the image is provided to the client.

Related to image cropping are region of interest transcoding hints. The region of interest transcoding hints can include the number of regions of interest, the location of the regions of interest, the shape of the regions of interest, the priority of the regions of interest, the method of regions of interest coding, the quantization value of the regions of interest and the type of regions of interest. Region of interest transcoding hints can be related to the bit rate transcoding hints, resolution transcoding hints, image cropping transcoding hints or can be a separate type of transcoding hint.

If the still image is stored in JPEG2000, a scaling based method for region of interest coding can be used. This region of interest scaling-based method scales up (shift up) coefficients of the image so that the bits associated with the region of interest are placed in higher bit-planes. During the embedded coding process of a JPEG2000 image, region of interest bits are placed in the bitstream before the non-region of interest elements of the image. Depending upon the scaling value, some bits of the region of interest coefficients may be encoded together with non-region of interest coefficients. Accordingly, the region of interest information of the image will be decoded, or refined, before the rest of the image if a full decoding of the bitstream results in a reconstruction of the whole image with the highest fidelity available. If the bitstream is truncated, or the encoding process is terminated before the whole image is fully encoded, the regions of interest will have a higher fidelity than the rest of the image.

A scaling based method in accordance with JPEG2000 can be implemented by initially calculating the wavelet transform. If a region of interest is selected, a region of interest mask is derived which indicates the set of coefficients that are required for up to lossless region of interest reconstruction. Next, the wavelet coefficients are quantized. The coefficients outside of the region of interest mask are downscaled by a specified scaling value. The resulting coefficients are encoded progressively with the most significant bit planes. The scaling value assigned to the region of interest and the coordinates of the region of interest are added to the bitstream so that the decoder also performs the region of interest mask generation and the scaling up of the downscaled coefficients.

There are two methods for region of interest coding in accordance with the JPEG2000 standard, the MAXSHIFT method and the “general scaling method”. The MAXSHIFT method does not require any shape information for the region of interest information to be transmitted to the receiver, whereas the “general scaling method” requires the shape information to be transmitted to the receiver.

Current JPEG encoded images, i.e., those which are not encoded in accordance with JPEG2000, can support region of interest coding using the way that coefficients in each 8×8 block are quantized. Accordingly, blocks that do not belong to the region of interest will have the DCT coefficients coarsely quantized, i.e., high quantization steps, while blocks that belong to the region of interest will have the DCT coefficients finely quantized, i.e., low quantization steps. The priority of region of interest transcoder hints indicates how important each region of interest is in the image. In accordance with the current JPEG standard, i.e., images not encoded in accordance with JPEG2000, the location and shape of the regions of interest may be omitted since decoding in the current JPEG is block based. Therefore, the Q step value in each block will indicate the importance of the particular block. By using a region of interest transcoding hints, particular regions of interest will maintain a higher quality than less important background regions of an image. It will be recognized that region of interest transcoding hints can also be considered as error resilience hints. For example, if an image is to be transmitted through wireless channels, the importance of the region of interest will also be used to provide these regions of interest with better error resilience protection compared to the remainder of the image.

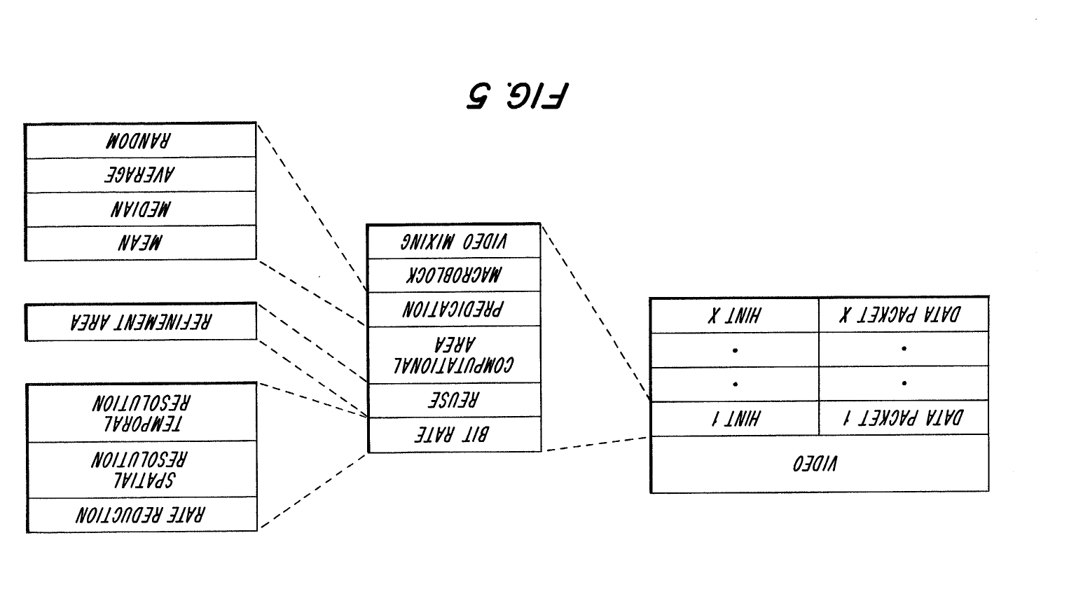

FIG. 5 illustrates various transcoding hints which can be used for transcoding video information. The transcoding hints can include bit rate hints, reuse hints, computational area hints, prediction hints, macroblock hints and video mixing hints. Bit rate hints can include information about rate reduction, spatial resolution or temporal resolution. All of these bit rate transcoder hints use variables which include the bandwidth range, the computational complexity range and the quality range for use in transcoding the video data. The bandwidth range represents the possible range in bandwidth that the sequence can be transcoded to. The computational complexity indicates the amount of processing power that the algorithm is consuming. The quality range indicates a measurement of how much the peak signal to noise ratio (PSNR) is lowered by performing the transcoding. These bit rate transcoder hints provide the transcoder with a rough idea of the possibility of different methods to offer when it comes to bandwidth, computational complexity and perceived quality.

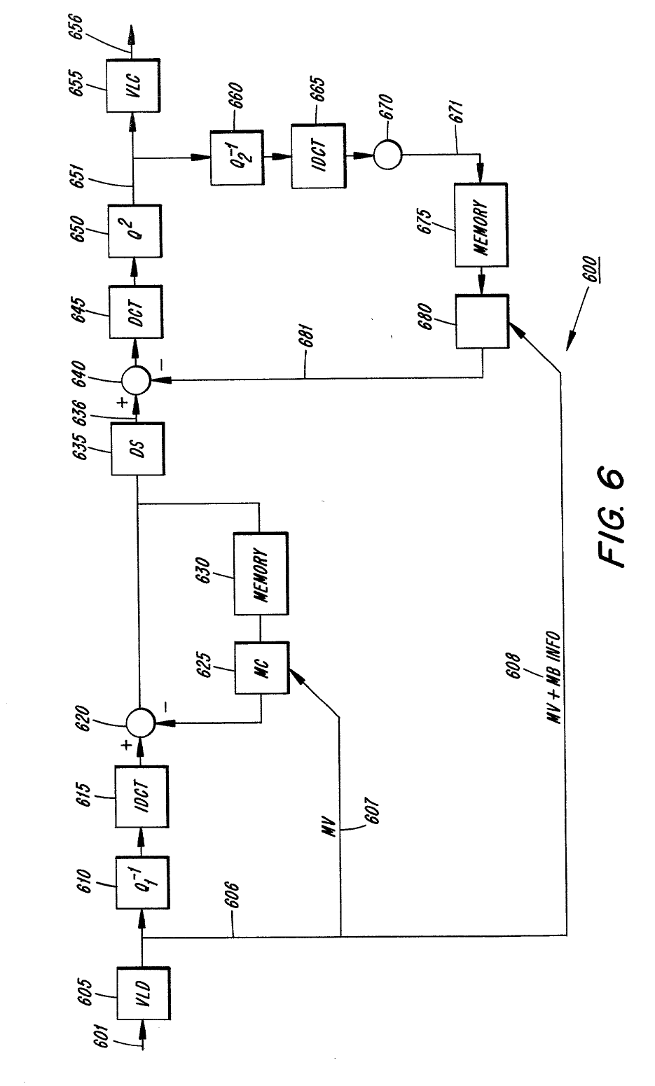

With reference to FIG. 6, an exemplary resolution reduction oriented intelligent transcoder 600 is shown. Further in accordance with, for example, the methods described in “A transcoder”, supra, when transcoding video data having a resolution CIF, CIF video data 601, to video data having a resolution QCIF, QCIF transcoded video 656, motion vectors (MVs) 607 associated with the original video may be re-used. MV 607 for example, may be extracted based on CIF resolution video 606. It should be noted however, that MVs 607 are not ideally suited for QCIF transcoded video 656. Therefore, MV refinement may be performed in QCIF transcoded video 656 by adding motion boundary MB 608 information to MV 607. Depending on the complexity of CIF resolution video 606, refinement may be performed in an area, for example, [−1,1] up to [−7, 7] pixels around the extracted MV 607, although larger refinement areas are also possible. Since transcoder 600 does not know in advance motion boundary MB 608, MV 607 for a small area may be refined thus produce a relatively low quality for QCIF transcoded video 656 based on high motion associated with CIF video data 601. Alternatively, refinement of MVs 607 may produce computational complexity when large refinement area was used based on low motion CIF video data 601. In addition, certain scenes of CIF video data 601 might be associated with high activity while others might be, associated with low activity. It would be preferable therefore for exemplary transcoder 600 to know which parts of CIF video data 601 will require a large refinement area and which require a small refinement area.

It will be recognized that the transcoder need not necessarily reuse the motion vectors as described above. The transcoder may recalculate the motion vectors from scratch. If this is performed, then transcoder hints can be supplied for the area of motion vector prediction. Since in video various scenes may have different levels of complexity, in some scenes motion vector refinement may be performed in a small area while in others it may be performed in a large area. Accordingly, by adding extra information to the motion vector transcoding hints, which includes the starting and ending frames for every motion vector refinement. For example, it can be specified that for a particular number of frames there is one motion vector refinement area, while for another number of frames, there is a different motion vector refinement area. The motion vector refinement area can be either extracted manually or automatically by the server. For example, camera motion information can be used or information about the activity of each scene can be used in the determination of the motion vector refinement area. The size of the motion vectors can also be used to determine the amount of motion in a video sequence.

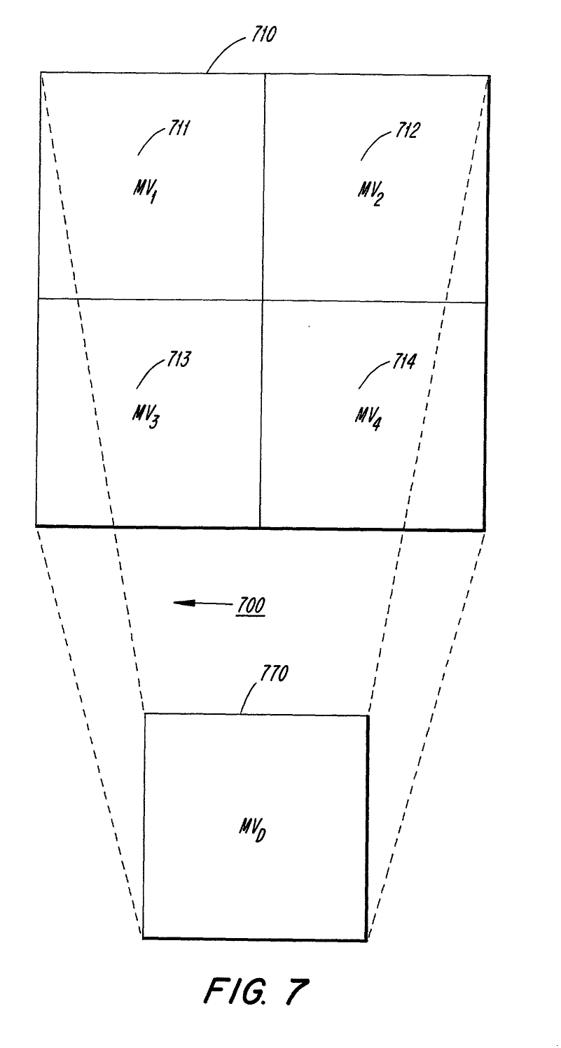

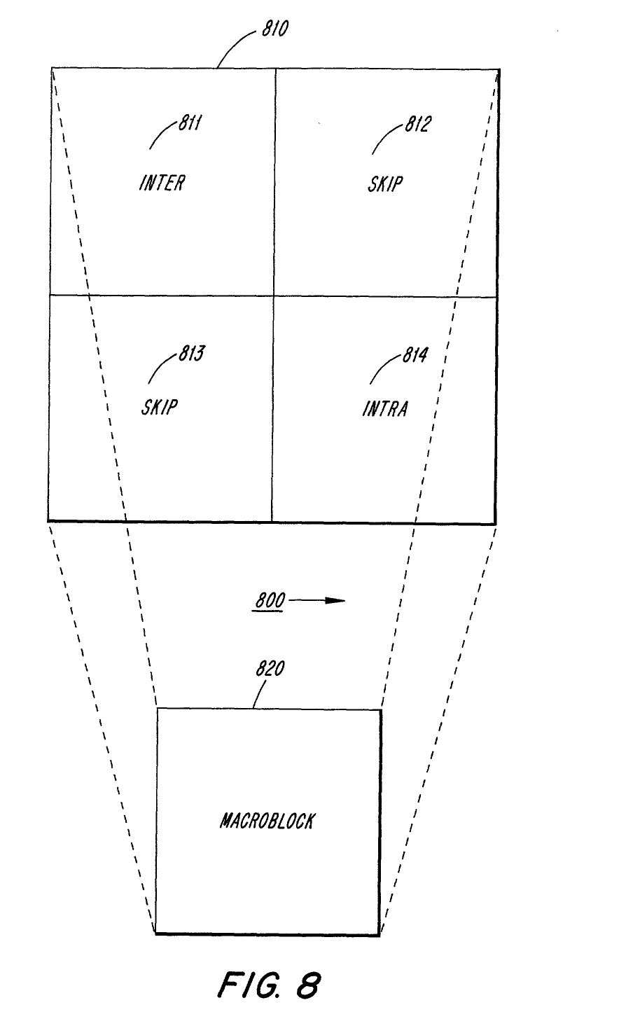

One issue with motion vector refinement is the prediction of the motion vector value. When transcoding from CIF to QCIF, four motion vectors on the CIF resolution need to be replaced by one in the QCIF resolution. FIG. 7 illustrates this process. Accordingly, the transcoder combines the four incoming motion vectors 711, 712, 713 and 714 in such a manner that it can produce one motion vector 770 per macroblock during the re-encoding process. The predicted motion vector, which can be refined later, is a scaled version of the medium, mean, average or random selection of one of the motion vectors of the four motion vectors of the CIF information. The transcoding hints can also inform the transcoder of the form of prediction to be used.

The different prediction transcoding hints will have different characteristics that the transcoder can use as information in the determination of which prediction method is the best to use at a particular moment in time based upon client capabilities, user preferences, link characteristics and/or network characteristics. These methods will vary in complexity and the amount of overhead bits they produce. The amount of overhead bits implicitly affects the quality of the video sequence. Compared to earlier hints, the computational complexity is now exactly known and thus the computational complexity parameter should be contained in the transcoder itself, and therefore, can be left out of the transcoding hints parameters.

When resolution reduction is implemented in a transcoder, a problem results with passing motion vectors appearing in passing macroblock type information. Although the macroblock coding types can be reevaluated at the encoder of the transcoder, a quicker method can be used to speed up the computation. The down sampling of four macroblock types to one macroblock. The four macroblock types 810 include an inter macroblock 811, skip macroblocks 812 and 813, and an intra block 814. If there is at least one intra block in the 16×16 macroblocks of the CIF encoded video, then the code of the corresponding macroblock in QCIF is intra. If all macroblocks were coded as skipped, then these macroblocks are also coded as skipped. If there was no intra macroblock but there was at least one inter macroblock, then the macroblock is coded in QCIF as inter. In addition, if there are no intra macroblocks but at least one inter macroblock, a further check is performed to determine if all coefficients after quantization are set to zero. If all coefficients after quantization are set to zero then the macroblock is coded as skipped.

If temporal resolution reduction is used, i.e., frame rate reduction, a simple method for reducing the frame rate is to drop some of the bidirectional predicted frames, the so-called B-frames, from the coded sequence. This changes the frame rate of the incoming video sequence. Which frames and how many frames to be dropped is determined in the transcoder. This decision depends upon a negotiation with the client and the target bit rate, i.e., the bit rate of the outgoing bitstream. The B-frames are coded using motion compensated prediction from past and/or future I-frames or P-frames. I-frames are compressed using intra frame coding, whereas P-frames are coded using motion compensated prediction from past I-frames or P-frames. Since B-frames are not used in the prediction of other B-frames or P-frames, a dropping of some of them will not affect the quality of the future frames. The motion vectors corresponding to the skipped B-frames will also be skipped.

It will be recognized that dropping frames can result in loss of important information. For example, some frames may be the beginning of a shot, i.e., of a new scene, or important key frames in a shot. Dropping these frames to reduce the frame rate might result in reduced performance. Therefore, these frames should be marked so that they are considered important. This marking would contain the frame number and a significant value associated with the frame. Accordingly, if the transcoder needs to drop key frames to achieve a certain frame rate, it will drop the least significant frames. This dropping of frames can be performed automatically through the use of key frame extraction algorithms or manually. The transcoder uses the frame reduction hints to decide how to transcode the video for reduced frame rate. For example, a transcoder can decide to deliver only frames corresponding to shot boundaries, followed by those corresponding to key frames or I-frames. An example of this can be an application where a user wants to perform quick browsing of a video and wants to see key shots of the video. The server sends only the shots and the user can decide for which shot he would prefer more information.

One type of video mixing transcoding hint can be a region of interest of the video where extra information is added without destroying the contents. For example, a particular portion of the video, such as the top right corner, could be used to add a clock or the logo of a company in a pixel-wise fixed place of the video. Another video mixing transcoding hint can be a list of points that are actually fixed in space that are moving in the video. A list of the positions of these fixed points in each frame together with a list of all objects that are currently in front of these points could be used by anyone to add an image that would appear in the fixed space in the video.

Although the present invention has been described above in connection with specific types of media and specific types of transcoder hints, it will be recognized that the present invention is equally applicable to all types of media. For example, transcoder hints can be used in connection with a document which is composed of various types of media, also known as a compound document. The associated transcoder hints for a compound document can include information which assists in text-to-speech conversion.

The invention has been described herein with reference to particular embodiments. However, it will be readily apparent to those skilled in the art that it may be possible to embody the invention in specific forms other than those described above. This may be done without departing from the spirit of the invention. Embodiments described above are merely illustrative and should not be considered restrictive in any way. The scope of the invention is given by the appended claims, rather than the preceding description, and all variations and equivalents which fall within the range of the claims are intended to be embraced therein.

What is claimed is:

1. A method for converting multimedia information comprising the steps of:
requesting multimedia information from a converter;
receiving the multimedia information along with conversion hints;
converting the multimedia information in accordance with the conversion hints; and
providing the multimedia information to the requester.

2. The method of claim 1, wherein the converter is a transcoder and the converter hints are transcoding hints.

3. The method of claim 1, further comprising the step of:
storing user preferences, wherein the multimedia information is converted to a multimedia format in accordance with the user preferences using the conversion hints.

4. The method of claim 1, further comprising the step of:
storing client capabilities, wherein the multimedia information is converted to a multimedia format in accordance with the client capabilities using the conversion hints.

5. The method of claim 1, further comprising the step of:
storing network or link capabilities, wherein the multimedia information is converted to a multimedia format in accordance with the network or link capabilities using the conversion hints.

6. The method of claim 2, wherein the multimedia data includes still images, and wherein the transcoding hints are selected from the group consisting of:
bitrate, resolution, frame size, color quantization, color pallette, color conversion, image to speech, Regions of Interest (ROI), and wavelet compression.

7. The method of claim 2, wherein the multimedia data includes motion video, and wherein the transcoding hints are selected from the group consisting of:
frame rate, spatial resolution, temporal resolution, motion vector prediction, macroblock coding, and video mixing.

8. The method of claim 1, wherein the conversion hints are stored along with the multimedia information prior to requesting the multimedia information.

9. An apparatus comprising:
a multimedia storage element which stores multimedia information;
a converter element which receives multimedia information from the multimedia storage element; and
a client,
wherein the converter element converts multimedia information using conversion hints and delivers the converted multimedia information to the client.

10. The apparatus of claim 9, wherein the converter is a transcoder and the converter hints are transcoding hints.

11. The apparatus of claim 9, wherein the converter elements stores user preferences, and wherein the multimedia information is converted to a multimedia format in accordance with the user preferences using the conversion hints.

12. The apparatus of claim 9, wherein the converter element stores client capabilities, and wherein the multimedia information is converted to a multimedia format in accordance with the client capabilities using the conversion hints.

13. The apparatus of claim 10, wherein the multimedia data includes still images, and wherein the transcoding hints are selected from the group consisting of:
bitrate, resolution, frame size, color quantization, color pallette, color conversion, image to speech, Regions of Interest (ROI), and wavelet compression.

14. The apparatus according to claim 10, wherein the multimedia data includes motion video, and wherein the transcoding hints are selected from the group consisting of:
frame rate, spatial resolution, temporal resolution, motion vector prediction, macroblock coding, and video mixing.

15. The apparatus of claim 9, wherein the conversion hints are stored along with the multimedia information prior to requesting the multimedia information.

16. The apparatus of claim 9, wherein the converter element stores network or link capabilities, and wherein the multimedia information is converted to a multimedia format in accordance with the network or link capabilities using the conversion hints.

17. The apparatus of claim 9, wherein the multimedia storage element is included in another client.
